(19) United States
(12) Patent Application Publication
(10) Pub. No.: US 2025/0246869 A1
(43) Pub. Date: Jul. 31, 2025

(54) DOUBLE-ENDED EXCITATION LASER AMPLIFIER AND METHOD OF MANUFACTURING ELECTRONIC DEVICE

(71) Applicant: Gigaphoton Inc., Tochigi (JP)

(72) Inventor: Yasuhiro KAMBA, Oyama-shi (JP)

(73) Assignee: Gigaphoton Inc., Tochigi (JP)

(21) Appl. No.: 18/977,397

(22) Filed: Dec. 11, 2024

(30) Foreign Application Priority Data
Jan. 30, 2024 (JP) 2024-011837

(51) Int. Cl. H01S 3/10; B23K 26/067; H01S 3/094; H01S 3/16

(52) U.S. Cl. CPC H01S 3/10061; B23K 26/067; H01S 3/094038; H01S 3/1618; H01S 3/1643

(57) ABSTRACT

A double-ended excitation laser amplifier includes a laser amplification medium configured to amplify pulsed seed light, an excitation light source configured to output excitation light, a first λ/4 wavelength plate and a first λ/2 wavelength plate through which the excitation light is transmitted, a first polarizing beam splitter configured to separate the excitation light transmitted through the first λ/4 wavelength plate and the first λ/2 wavelength plate into first light having a first polarization direction and second light having a second polarization direction, a first incident optical system configured to cause the first light to be incident on a first end of the laser amplification medium, and a second incident optical system configured to cause the second light to be incident on a second end of the laser amplification medium.

### CROSS-REFERENCE TO RELATED APPLICATIONS

The present application claims the benefit of Japanese Patent Application No. 2024-011837, filed on Jan. 30, 2024, the entire contents of which are hereby incorporated by reference.

### BACKGROUND

### 1. Technical Field

The present disclosure relates to a double-ended excitation laser amplifier and a method of manufacturing an electronic device.

### 2. Related Art

In recent years, improvement in resolution in semiconductor exposure apparatuses has been desired with miniaturization and high integration of semiconductor integrated circuits. For this purpose, exposure light sources that output light having shorter wavelengths have been developed. For example, as gas laser devices for exposure, a KrF excimer laser device that outputs laser light having a wavelength of about 248 nm and an ArF excimer laser device that outputs a laser light having a wavelength of about 193 nm are used.

### LIST OF DOCUMENTS

### Patent Documents

Patent Document 1: U.S. Pat. No. 5,412,683
Patent Document 2: Japanese Unexamined Patent Application Publication No. 2016-051897
Patent Document 3: U.S. Unexamined Patent Application Publication No. 2009/245304

### Non-Patent Document

Non-patent Document 1: Luo Guangxin, Liu Yinfei, Song Jiajun, et al. A double-ended pump thin-rod Yb:YAG regenerative amplifier with high average power and excellent beam quality [DS/OL]. V1. Science Data Bank, 2023 [2024 Jan. 21].
https://cstr.cn/31253.11.sciencedb.07851.
CSTR: 31253.11.sciencedb.07851.

### SUMMARY

A double-ended excitation laser amplifier according to an aspect of the present invention includes a laser amplification medium configured to amplify pulsed seed light, an excitation light source configured to output excitation light, a first λ/4 wavelength plate and a first λ/2 wavelength plate through which the excitation light is transmitted, a first polarizing beam splitter configured to separate the excitation light transmitted through the first λ/4 wavelength plate and the first λ/2 wavelength plate into first light having a first polarization direction and second light having a second polarization direction, a first incident optical system configured to cause the first light to be incident on a first end of the laser amplification medium, and a second incident optical system configured to cause the second light to be incident on a second end of the laser amplification medium.

A double-ended excitation laser amplifier according to an aspect of the present disclosure includes a laser amplification medium configured to amplify pulsed seed light, an excitation light source configured to output excitation light that is linearly polarized light, a first λ/2 wavelength plate through which the excitation light is transmitted, a first polarizing beam splitter configured to separate the excitation light transmitted through the first λ/2 wavelength plate into first light having a first polarization direction and second light having a second polarization direction, a first incident optical system configured to cause the first light to be incident on a first end of the laser amplification medium, and a second incident optical system configured to cause the second light to be incident on a second end of the laser amplification medium.

A method of manufacturing an electronic device according to an aspect of the present disclosure includes generating laser light with a laser device, the laser device including a seed laser configured to output pulsed seed light, a laser amplification medium configured to amplify the seed light, an excitation light source configured to output excitation light, a first λ/4 wavelength plate and a first λ/2 wavelength plate through which the excitation light is transmitted, a first polarizing beam splitter configured to separate the excitation light transmitted through the first λ/4 wavelength plate and the first λ/2 wavelength plate into first light having a first polarization direction and second light having a second polarization direction, a first incident optical system configured to cause the first light to be incident on a first end of the laser amplification medium, and a second incident optical system configured to cause the second light to be incident on a second end of the laser amplification medium, producing an interposer by laser processing on an interposer substrate with the laser light, coupling and electrically connecting the interposer and an integrated circuit chip to each other, and coupling and electrically connecting the interposer and a circuit substrate to each other.

A method of manufacturing an electronic device according to an aspect of the present disclosure includes generating laser light with a laser device, the laser device including a seed laser configured to output pulsed seed light, a laser amplification medium configured to amplify the seed light, an excitation light source configured to output excitation light that is linearly polarized light, a first λ/2 wavelength plate through which the excitation light is transmitted, a first polarizing beam splitter configured to separate the excitation light transmitted through the first λ/2 wavelength plate into first light having a first polarization direction and second light having a second polarization direction, a first incident optical system configured to cause the first light to be incident on a first end of the laser amplification medium, and a second incident optical system configured to cause the second light to be incident on a second end of the laser amplification medium, producing an interposer by laser processing on an interposer substrate with the laser light, coupling and electrically connecting the interposer and an integrated circuit chip to each other, and coupling and electrically connecting the interposer and a circuit substrate to each other.

### BRIEF DESCRIPTION OF THE DRAWINGS

Embodiments of the present disclosure will be described below merely as examples with reference to the accompanying drawings.

FIG. 1 illustrates a configuration of a laser processing system in a comparative example.

FIG. 2 illustrates a configuration of a laser amplifier according to a first embodiment.

FIG. 3 illustrates a configuration of a first λ/4 wavelength plate.

FIG. 4 illustrates a configuration of a first λ/2 wavelength plate.

FIG. 5 illustrates a configuration of a laser amplifier according to a first modification of the first embodiment.

FIG. 6 illustrates a configuration of a laser amplifier according to a second modification of the first embodiment.

FIG. 7 illustrates a configuration of a laser amplifier according to a second embodiment.

FIG. 8 is a perspective view of a third polarizing beam splitter and illustrates an interior of a bounding outline VIII shown in FIG. 7 in greater detail.

FIG. 9 illustrates a configuration of a laser amplifier according to a third embodiment.

FIG. 10 schematically illustrates a configuration of an electronic device.

FIG. 11 is a flowchart illustrating a method of manufacturing an electronic device.

### DESCRIPTION OF EMBODIMENTS

### <Contents>

1. Comparative example
   1.1 Configuration
   1.2 Operation
   1.3 Problems of comparative example
2. Laser amplifier 1a that adjusts division ratio by adjusting polarization state
   2.1 Configuration
   2.2 Operation
   2.3 First modification
      2.3.1 Configuration
      2.3.2 Operation
   2.4 Second modification
   2.5 Effects
3. Laser amplifier 1d capable of adjusting each of amounts of first and second light
   3.1 Configuration
   3.2 Operation
      3.2.1 Light amount adjustment for first light
      3.2.2 Light amount adjustment for second light
   3.3 Effects
4. Laser amplifier 1e including pump laser PL₃ that outputs linearly polarized light
   4.1 Configuration
   4.2 Operation
   4.3 Effects
5. Others
   5.1 Electronic device including interposer IP
   5.2 Supplement

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numerals, and duplicate description thereof is omitted.

### 1. Comparative Example

### 1.1 Configuration

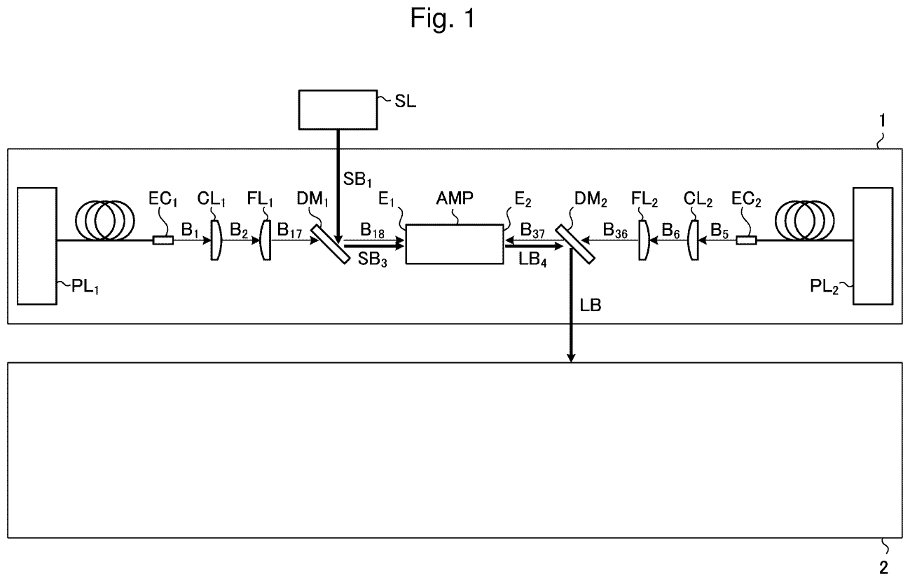

FIG. 1 illustrates a configuration of a laser processing system in a comparative example. The comparative example of the present disclosure is an example recognized by the applicant as known only by the applicant, and is not a publicly known example admitted by the applicant. The laser processing system includes a seed laser SL, a laser amplifier 1, and a laser irradiation device 2.

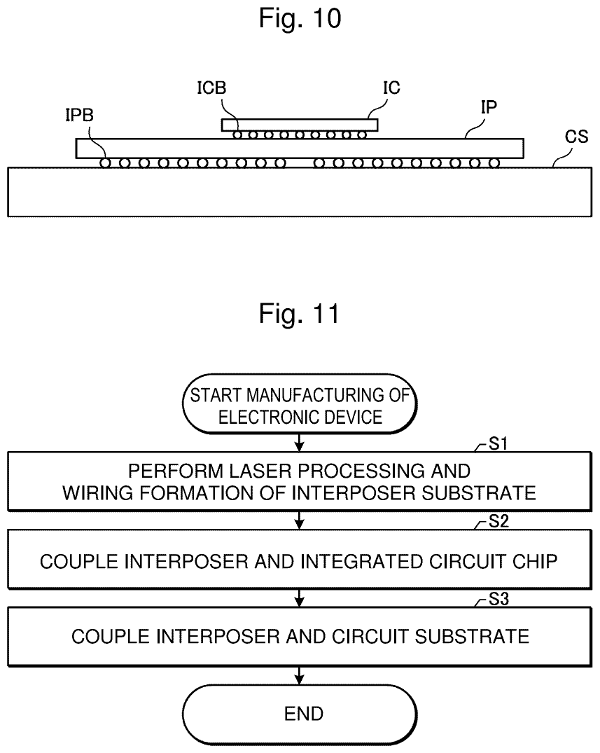

The seed laser SL is a laser oscillator that outputs pulsed seed light SB₁. The wavelength of the seed light SB₁ is, for example, about 1030 nm. The laser amplifier 1 amplifies the seed light SB₁ and outputs pulsed laser light LB. The laser light LB may be converted into an oscillating wavelength of a KrF excimer laser device or an ArF excimer laser device, which is not illustrated, and may be further amplified by such an excimer laser device. The laser irradiation device 2 includes an unillustrated irradiation optical system for irradiating an unillustrated workpiece with the laser light LB. The workpiece is, for example, an interposer substrate for manufacturing an interposer IP that relays an integrated circuit chip IC and a circuit substrate CS, which will be described later referring to FIG. 10.

The laser amplifier 1 includes pump lasers PL₁ and PL₂, end caps EC₁ and EC₂, collimating lenses CL₁ and CL₂, focusing lenses FL₁ and FL₂, dichroic mirrors DM₁ and DM₂, and a laser amplification medium AMP.

The laser amplification medium AMP is, for example, an Yb:YAG (Ytterbium-doped Yttrium Aluminum Garnet) crystal.

The pump lasers PL₁ and PL₂ are excitation light sources for outputting excitation light, and include, for example, a semiconductor laser or a solid-state laser. The wavelength of the excitation light is set in accordance with the absorption wavelength of the laser amplification medium AMP. When the laser amplification medium AMP is an Yb:YAG crystal, the wavelength of the excitation light is set to either 940 nm or 969 nm.

The end caps EC₁ and EC₂ are disposed at respective output ends of optical fibers connected to the pump lasers PL₁ and PL₂.

The collimating lenses CL₁ and CL₂ are disposed in respective optical paths of the excitation light B₁ and B₅ exiting the end caps EC₁ and EC₂. The focal lengths of the collimating lenses CL₁ and CL₂ are, for example, 12 mm.

The focusing lenses FL₁ and FL₂ are disposed in respective optical paths of the excitation light B₂ and B₆ exiting the collimating lenses CL₁ and CL₂. The focal lengths of the focusing lenses FL₁ and FL₂ are, for example, 250 mm. The focusing lenses FL₁ and FL₂ correspond to first and second incident optical systems of the present disclosure, respectively.

The dichroic mirrors DM₁ and DM₂ are disposed obliquely with respect to an optical path axis of the seed light SB₁ output from the seed laser SL and optical path axes of the excitation light B₁₇ and B₃₆ exiting the focusing lenses FL₁ and FL₂, respectively. The dichroic mirrors DM₁ and DM₂ are configured to reflect wavelength components included in the seed light SB₁ and transmit wavelength components included in the excitation light B₁₇ and B₃₆.

### 1.2 Operation

The excitation light output from the pump laser PL₁ and the excitation light output from the pump laser PL₂ respectively exits the end caps EC₁ and EC₂ as excitation light B₁ and excitation light B₅, each of which is diverging light. The excitation light B₁ and the excitation light B₅ are respectively converted into excitation light B₂ and excitation light B₆, each of which is collimated light, by the collimating lenses CL₁ and CL₂. The excitation light B₂ and the excitation light B₆ are respectively converted into excitation light B₁₇ and excitation light B₃₆, each of which is converging light, by the focusing lenses FL₁ and FL₂. Only the optical path axis of the light beam is shown in each drawing.

The excitation light B₁₇ exiting the focusing lens FL₁ is transmitted through the dichroic mirror DM₁ and is collected on a first end E₁ of the laser amplification medium AMP as excitation light B₁₈. The excitation light B₃₆ exiting the focusing lens FL₂ is transmitted through the dichroic mirror DM₂ and is collected on a second end E₂ of the laser amplification medium AMP as excitation light B₃₇. It is desirable that the excitation light B₁₈ and the excitation light B₃₇ incident on the laser amplification medium AMP be coaxial with each other. The coaxial configuration is not limited to a case where the optical path axes of the two light beams are perfectly coincident with each other and includes an error within a practical range, for example, an error within 1°.

The seed light SB₁ exiting the seed laser SL is reflected by the dichroic mirror DM₁ and enters the first end E₁ as a seed light SB₃.

The laser amplification medium AMP is excited by energy of the excitation light B₁₈ and B₃₇ and amplifies the seed light SB₃. The amplified seed light SB₃ exits the second end E₂ as laser light LB₄.

The laser light LB₄ exiting the second end E₂ of the laser amplification medium AMP is reflected by the dichroic mirror DM₂ and is output as laser light LB.

The excitation light B₁₈ and the excitation light B₃₇ are, for example, continuous-wave laser light. Alternatively, the excitation light B₁₈ and the excitation light B₃₇ may be pulsed laser light, and in that case, synchronous control is performed in which the pulses of the seed light SB₃ and the pulses of the excitation light B₁₈ and B₃₇ overlap in the laser amplification medium AMP.

It is desirable that the excitation light B₁₈ and the excitation light B₃₇ be adjusted to have the same amount of light. In order to adjust the light amounts of the excitation light B₁₈ and the excitation light B₃₇, application voltages to be applied to the pump lasers PL₁ and PL₂ are controlled, for example.

### 1.3 Problems of Comparative Example

The excitation light B₁₈ and the excitation light B₃₇ are not all absorbed in the laser amplification medium AMP. Light that has not been absorbed in the laser amplification medium AMP in the excitation light B₁₈ exits the second end E₂, is transmitted through the dichroic mirror DM₂, the focusing lens FL₂, and the collimating lens CL₂, is then incident on the end cap EC₂, and may damage the pump laser PL₂. Light that has not been absorbed in the laser amplification medium AMP in the excitation light B₃₇ may similarly damage the pump laser PL₁. Alternatively, energy of the light may heat and damage the end caps EC₁ and EC₂.

Furthermore, in the comparative embodiment, it may not be easy to set the amounts of the excitation light B₁₈ and the excitation light B₃₇ that are to be incident on the laser amplification medium AMP.

Embodiments described below relate to a double-ended excitation laser amplifier capable of suppressing damage on the pump lasers PL₁ and PL₂ due to the excitation light that has not been absorbed in the laser amplification medium AMP and further setting the amounts of the excitation light B₁₈ and the excitation light B₃₇ that are to be incident on the laser amplification medium AMP.

### 2. Laser Amplifier 1a that Adjusts Division Ratio by Adjusting Polarization State

### 2.1 Configuration

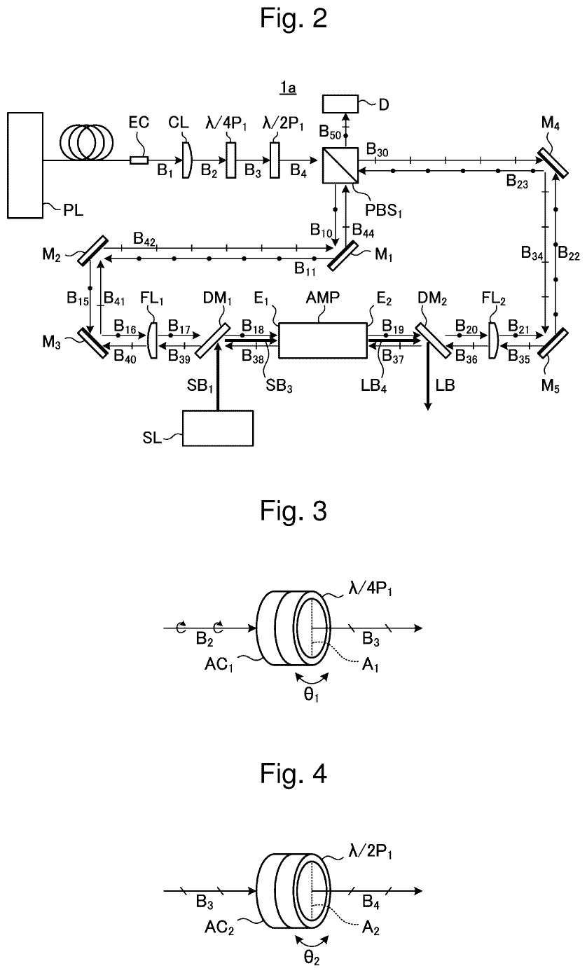

FIG. 2 illustrates a configuration of a laser amplifier 1a according to a first embodiment. The laser amplifier 1a is an example of a double-ended excitation laser amplifier in the present disclosure. The laser amplifier 1a includes a pump laser PL, an end cap EC, a collimating lens CL, a first λ/4 wavelength plate λ/4P₁, a first λ/2 wavelength plate λ/2P₁, a first polarizing beam splitter PBS₁, and a high reflective mirrors M₁ to M₅.

The pump laser PL, the end cap EC, and the collimating lens CL are similar to the pump laser PL₁, the end cap EC₁, and the collimating lens CL₁ in the comparative example, respectively. The laser amplifier 1a may not include the pump laser PL₂, the end cap EC₂, and the collimating lens CL₂. The laser amplifier 1a further includes focusing lenses FL₁ and FL₂, dichroic mirrors DM₁ and DM₂, and a laser amplification medium AMP, which are similar to those described in the comparative example.

The first λ/4 wavelength plate λ/4P₁ is disposed in an optical path of excitation light B₂ exiting the collimating lens CL.

FIG. 3 illustrates a configuration of the first λ/4 wavelength plate λ/4P₁. The first λ/4 wavelength plate λ/4P₁ provides a phase difference of λ/4 of a wavelength 2 of excitation light B₂ between a polarization component parallel to an optical axis A₁ and a polarization component perpendicular to the optical axis A₁ in the incident excitation light B₂. Thus, the first λ/4 wavelength plate λ/4P₁ changes the polarization state of the excitation light B₂ and causes the excitation light B₂ to exit therefrom as excitation light B₃. The polarization state of the excitation light B₃ is determined by the polarization state of the excitation light B₂ and the direction of the optical axis A₁. In an example, when the excitation light B₂ incident on the first λ/4 wavelength plate λ/4P₁ includes a circularly polarized light component or an elliptically polarized light component, the excitation light B₃ including a linearly polarized light component may exit therefrom. If the first λ/4 wavelength plate λ/4P₁ is rotated by a rotation mechanism AC₁ as indicated by an arrow θ₁, the direction of the optical axis A₁ is changed, and the polarization state of the excitation light B₃ is adjusted. The rotation mechanism AC₁ corresponds to the second rotation mechanism in the present disclosure.

Referring back to FIG. 2, the first λ/2 wavelength plate λ/2P₁ is disposed in an optical path of the excitation light B₃ exiting the first λ/4 wavelength plate λ/4P₁. Alternatively, the positional relationship between the first λ/4 wavelength plate λ/4P₁ and the first λ/2 wavelength plate λ/2P₁ may be reversed.

FIG. 4 illustrates a configuration of the first λ/2 wavelength plate λ/2P₁. The first λ/2 wavelength plate λ/2P₁ provides a phase difference of λ/2 of the wavelength λ of the excitation light B₃ between a polarization component parallel to the optical axis A₂ and a polarization component perpendicular to the optical axis A₂ in the incident excitation light B₃. Thus, the first λ/2 wavelength plate λ/2P₁ changes the polarization state of the excitation light B₃ and causes the excitation light B₃ to exit therefrom as excitation light B₄. A polarization state of the excitation light B₄ is determined by the polarization state of the excitation light B₃ and the direction of the optical axis A₂. For example, when the direction of the optical axis A₂ is inclined by an angle ¢ with respect to the polarization direction of the excitation light B₃ that is linearly polarized light incident on the first λ/2 wavelength plate λ/2P₁, the excitation light B₄ that is linearly polarized light with a polarization direction inclined by an angle 2ϕ with respect to the polarization direction of the excitation light B₃ exits therefrom. When the first λ/2 wavelength plate λ/2P₁ is rotated by the rotation mechanism AC₂ as indicated by an arrow θ₂, the direction of the optical axis A₂ is changed, and the polarization state of the excitation light B₄ is adjusted. The rotation mechanism AC₂ corresponds to a first rotation mechanism in the present disclosure.

Referring back to FIG. 2, the first polarizing beam splitter PBS₁ includes an optical thin film that transmits a P-polarized component and reflects an S-polarized component. For example, if the polarization direction of the excitation light B₄ is inclined by 45° with respect to the incident surface of the excitation light B₄ on the optical thin film, the amounts of the P-polarized light component and the S-polarized light component of the excitation light B₄ become equal to each other. In this case, excitation light B₁₀ reflected by the first polarizing beam splitter PBS₁ and excitation light B₃₀ transmitted through the first polarizing beam splitter PBS₁ have substantially the same amount of light.

### 2.2 Operation

The excitation light output from the pump laser PL exits the end cap EC as excitation light B₁ and is transmitted through the collimating lens CL as excitation light B₂. The excitation light B₂ is transmitted through the first λ/4 wavelength plate λ/4P₁ and the first λ/2 wavelength plate λ/2P₁ and then exits from the first λ/2 wavelength plate λ/2P₁ as excitation light B₄ in an adjusted polarization state. The first polarizing beam splitter PBS₁ separates the excitation light B₄ into the excitation light B₁₀ and the excitation light B₃₀. The polarization direction of the excitation light B₁₀ is a first polarization direction perpendicular to the plane of FIG. 2, and the polarization direction of the excitation light B₃₀ is the second polarization direction parallel to the plane of FIG. 2.

The excitation light B₁₀ is reflected by the high reflective mirrors M₁, M₂ and M₃ as excitation light B₁₁, B₁₅, and B₁₆, respectively. The excitation light B₁₆ is transmitted through the focusing lens FL₁ and the dichroic mirror DM₁ as excitation light B₁₇ and B₁₈, respectively, and is incident on a first end E₁ of the laser amplification medium AMP.

The excitation light B₃₀ is reflected by the high reflective mirrors M₄ and M₅ as excitation light B₃₄ and B₃₅, respectively. The excitation light B₃₅ is transmitted through the focusing lens FL₂ and the dichroic mirror DM₂ as excitation light B₃₆ and B₃₇, respectively, and is incident on a second end E₂ of the laser amplification medium AMP.

Light from the excitation light B₁₀ to the excitation light B₁₈ and light from the excitation light B₃₀ to the excitation light B₃₇ correspond to first and second light in the present disclosure, respectively. It is desirable that the light amounts of the first light and the second light be the same. Here, the same amount is not limited to a case where the amounts are completely coincident with each other and includes an error within 5%. Furthermore, it is desirable that the optical path lengths of the first light and the second light from the first polarizing beam splitter PBS₁ to the laser amplification medium AMP be the same.

Light that has not been absorbed in the laser amplification medium AMP in the excitation light B₁₈ may exit the second end E₂ as excitation light B₁₉, may propagate through the dichroic mirror DM₂, the focusing lens FL₂, and the high reflective mirrors M₅ and M₄ as excitation light B₂₀, B₂₁, and B₂₂, and may be incident on the first polarizing beam splitter PBS₁ as excitation light B₂₃. The excitation light B₂₃ has a polarization direction perpendicular to the plane of FIG. 2, is S-polarized with respect to the optical thin film of the first polarizing beam splitter PBS₁, and is therefore reflected as excitation light B₅₀. Thus, damage on the pump laser PL and the end cap EC can be suppressed. A beam damper D is disposed in an optical path of the excitation light B₅₀.

Light that has not been absorbed in the laser amplification medium AMP in the excitation light B₃₇ may exit the first end E₁ as excitation light B₃₈, may propagate through the dichroic mirror DM₁, the focusing lens FL₁, and the high reflective mirrors M₃, M₂, and M₁ as excitation light B₃₉, B₄₀, B₄₁ and B₄₂, and may be incident on the first polarizing beam splitter PBS₁ as excitation light B₄₄. The excitation light B₄₄ has a polarization direction parallel to the plane of FIG. 2, is P-polarized with respect to the optical thin film of the first polarizing beam splitter PBS₁, and is therefore transmitted as excitation light B₅₀. Thus, damage on the pump laser PL and the end cap EC can be suppressed.

The seed light SB₁ and SB₃ and the laser light LB₄ and LB are the same as those of the comparative example.

In other respects, the first embodiment is similar to the comparative example.

### 2.3 First Modification

### 2.3.1 Configuration

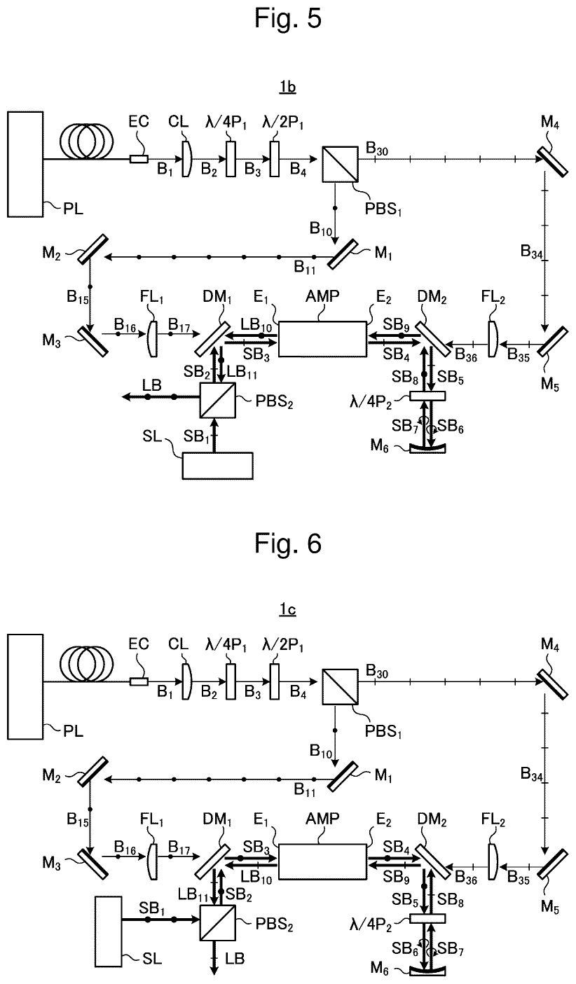

FIG. 5 illustrates a configuration of a laser amplifier 1b according to a first modification of the first embodiment. The laser amplifier 1b is an example of a double-ended excitation laser amplifier in the present disclosure. The laser amplifier 1b differs from the laser amplifier 1a in that the laser amplifier 1b includes a second polarizing beam splitter PBS₂, a second λ/4 wavelength plate λ/4P₂, and a high reflective mirror M₆ as a configuration that amplifies the seed light SB₁ twice and outputs the laser light LB. Illustration of the beam damper D and a part of the excitation light is omitted.

The second polarizing beam splitter PBS₂ is disposed in an optical path of the seed light SB₁ that is linearly polarized light. The seed light SB₁ has a third polarization direction parallel to the plane of FIG. 5 and is P-polarized with respect to the optical thin film of the second polarizing beam splitter PBS₂.

The second λ/4 wavelength plate λ/4P₂ is disposed in an optical path of the seed light SB₅ exiting the second end E₂ of the laser amplification medium AMP and reflected by the dichroic mirror DM₂. The seed light SB₅ has a third polarization direction parallel to the plane of FIG. 5, and the direction of the optical axis of the second λ/4 wavelength plate λ/4P₂ is inclined by 45° with respect to the third polarization direction. There may be no mechanisms for rotating the second λ/4 wavelength plate λ/4P₂.

The high reflective mirror M₆ is a concave mirror arranged in an optical path of the seed light SB₆ transmitted through the second λ/4 wavelength plate λ/4P₂. Instead of the high reflective mirror M₆, a combination of a planar mirror and a convex lens may be used.

### 2.3.2 Operation

The seed light SB₁ is transmitted through the second polarizing beam splitter PBS₂ as seed light SB₂, is reflected by the dichroic mirror DM₁ as seed light SB₃, and is then incident on the first end E₁ of the laser amplification medium AMP.

The seed light SB₄ amplified once by the laser amplification medium AMP exits the second end E₂, is reflected as seed light SB₅ by the dichroic mirror DM₂, and is transmitted through the second λ/4 wavelength plate λ/4P₂. The second λ/4 wavelength plate λ/4P₂ converts the seed light SB₅ that is linearly polarized light into seed light SB₆ that is circularly polarized light and causes the seed light SB₆ to be incident on the high reflective mirror M₆.

The high reflective mirror M₆ reflects the seed light SB₆ as seed light SB₇. The seed light SB₇ passes through the same optical paths as those of the seed light SB₆, SB₅ and SB₄ in the opposite direction as the seed light SB₇, SB₈ and SB₉ and returns to the second end E₂. When the seed light SB₇ is transmitted through the second λ/4 wavelength plate λ/4P₂ again, the second λ/4 wavelength plate λ/4P₂ converts the seed light SB₇ that is circularly polarized light into seed light SB₈ that is linearly polarized light. The polarization direction of the seed light SB₈ is a fourth polarization direction perpendicular to the polarization direction of the seed light SB₅.

The seed light SB₉ incident on the laser amplification medium AMP is amplified again, exits the first end E₁ as laser light LB₁₀, is reflected by the dichroic mirror DM₁ as laser light LB₁, and is then incident on the second polarizing beam splitter PBS₂. The laser light LB₁₁ has a fourth polarization direction perpendicular to the plane of FIG. 5 and is S-polarized with respect to the optical thin film of the second polarizing beam splitter PBS₂. The laser light LB₁ is reflected by the second polarizing beam splitter PBS₂ as laser light LB and is output from the laser amplifier 1b.

In other respects, the first modification is the same as the first embodiment.

### 2.4 Second Modification

FIG. 6 illustrates a configuration of a laser amplifier 1c according to a second modification of the first embodiment. The laser amplifier 1c is an example of a double-ended excitation laser amplifier in the present disclosure. Although the configuration and the operation of the laser amplifier 1c are substantially similar to those of the laser amplifier 1b, the configurations and the operations differ in the following points.
The optical paths of the seed light SB₁ and the laser light LB are switched and the traveling direction is reversed.
The polarization directions of the linearly polarized seed light SB₁ to SB₅, SB₈, and SB₉ and the laser light LB₁₀, LB₁₁, and LB are rotated by 90°.
The rotation directions of the circularly polarized seed light SB₆ and SB₇ are reversed.

### 2.5 Effects

(1) According to the first embodiment, the laser amplifier 1a includes the laser amplification medium AMP configured to amplify the pulsed seed light SB₁, the pump laser PL configured to output the excitation light B₁, the first λ/4 wavelength plate λ/4P₁ and the first λ/2 wavelength plate λ/2P₁ through which the excitation light B₂ is transmitted, the first polarizing beam splitter PBS₁, and the focusing lenses FL₁ and FL₂. The first polarizing beam splitter PBS₁ separates the excitation light B₄ transmitted through the first λ/4 wavelength plate λ/4P₁ and the first λ/2 wavelength plate λ/2P₁ into first light having a first polarization direction perpendicular to the plane of FIG. 2 and second light having a second polarization direction parallel to the plane of FIG. 2. The focusing lens FL₁ causes the first light to be incident on the first end E₁ of the laser amplification medium AMP, and the focusing lens FL₂ causes the second light to be incident on the second end E₂ of the laser amplification medium AMP.

With this configuration, the ratio of the light amounts of the first light and the second light can be set, and the amounts of the excitation light B₁₈ and the excitation light B₃₇ incident on the laser amplification medium AMP can be set, by defining the polarization state of the excitation light B₄ with the first λ/4 wavelength plate λ/4P₁ and the first λ/2 wavelength plate λ/2P₁. In addition, damage on the pump laser PL due to the excitation light B₁₉ and the excitation light B₃₈ that have not been absorbed in the laser amplification medium AMP can be suppressed.

(2) According to the first embodiment, the laser amplifier 1a further includes the rotation mechanism AC₂ configured to rotate the first λ/2 wavelength plate λ/2P₁ to change the optical axis A₂ of the first λ/2 wavelength plate λ/2P₁.

With this configuration, it is possible to change the ratio of the light amounts of the first light and the second light by rotating the polarization direction of the excitation light B₄.

(3) According to the first embodiment, the laser amplifier 1a further includes the rotation mechanism AC₁ configured to rotate the first λ/4 wavelength plate λ/4P₁ to change the optical axis A₁ of the first λ/4 wavelength plate λ/4P₁.

With this configuration, the polarization status of the excitation light B₃ can be changed, and the amounts of the excitation light B₁₈ and the excitation light B₃₇ incident on the laser amplification medium AMP can be finely adjusted, by rotating the first λ/4 wavelength plate λ/4P₁.

(4) According to the first and second modifications of the first embodiment, the laser amplifiers 1b and 1c further include the second polarizing beam splitter PBS₂, the high reflective mirror M₆, and the second λ/4 wavelength plate λ/4P₂. The second polarizing beam splitter PBS₂ causes the seed light SB₁ that is linearly polarized light having the third polarization direction parallel to the plane of FIG. 5 or perpendicular to the plane of FIG. 6 to be transmitted therethrough and causes the seed light SB₁ to be incident on the first end E₁. The high reflective mirror M₆ reflects the seed light SB₆ exiting the second end E₂ and returns the seed light SB₆ to the second end E₂. The second λ/4 wavelength plate λ/4P₂ is located in the optical path of the seed light SB₅ between the second end E₂ and the high reflective mirror M₆, and is disposed to convert the linearly polarized light having the third polarization direction to circularly polarized light when the seed light SB₅ directed from the second end E₂ to the high reflective mirror M₆ passes therethrough, and to convert the circularly polarized light to linearly polarized light having a fourth polarization direction perpendicular to the plane of FIG. 5 or parallel to the plane of FIG. 6 when the seed light SB₇ directed from the high reflective mirror Me to the second end E₂ passes therethrough. The second polarizing beam splitter PBS₂ is disposed in the optical path of the laser light LB₁₁, the laser light LB₁₁ being obtained by amplifying the seed light SB₉ that is the linearly polarized light having the fourth polarization direction and exiting the first end E₁.

With this configuration, it is possible to output high-energy laser light LB by amplifying the seed light SB₁ twice in the laser amplification medium AMP.

(5) According to the first embodiment, the first light and the second light have the same amount of light.

With this configuration, the laser amplification medium AMP can be efficiently excited.

(6) According to the first embodiment, the laser amplification medium AMP is an Yb:YAG crystal, and the excitation light B₁ includes any of 940 nm and 969 nm wavelength components.

With this configuration, the laser amplification medium AMP can efficiently absorb energy of the excitation light B₁.

(7) According to the first embodiment, the excitation light B₁ is continuous-wave light.

With this configuration, it is possible to amplify the seed light SB₁ even without adjusting pulse timings between the excitation light B₁ and the seed light SB₁.

### 3. Laser Amplifier 1d Capable of Adjusting Each of Amounts of First and Second Light

### 3.1 Configuration

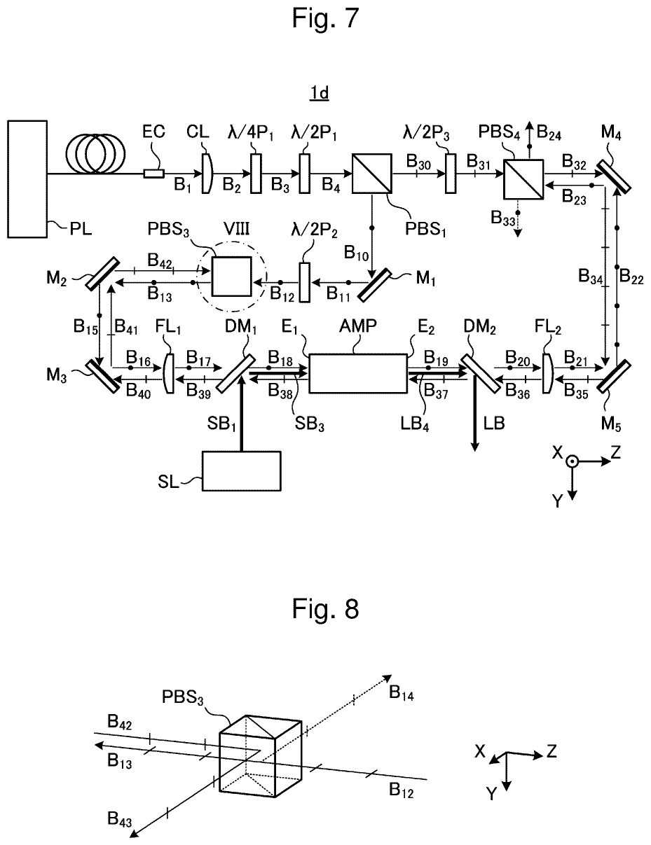

FIG. 7 illustrates a configuration of a laser amplifier 1d according to a second embodiment. The laser amplifier 1d is an example of a double-ended excitation laser amplifier in the present disclosure. The laser amplifier 1d differs from the laser amplifier 1a according to the first embodiment in that the laser amplifier 1d includes second and third λ/2 wavelength plates λ/2P₂ and λ/2P₃ and third and fourth polarizing beam splitters PBS₃ and PBS₄ and includes several beam dampers, which are not illustrated, instead of the beam damper D.

The second λ/2 wavelength plate λ/2P₂ is disposed in an optical path of excitation light Bu reflected by a first polarizing beam splitter PBS₁ and a high reflective mirror M₁. The second λ/2 wavelength plate λ/2P₂ is configured to be rotated by a rotation mechanism similar to the rotation mechanism AC₂ described above referring to FIG. 4, allowing for rotation of a direction of an optical axis A₂. The rotation mechanism that rotates the second λ/2 wavelength plate λ/2P₂ corresponds to a third rotation mechanism in the present disclosure.

The third polarizing beam splitter PBS₃ is disposed in an optical path of excitation light B₁₂ transmitted through the second λ/2 wavelength plate λ/2P₂.

FIG. 8 is a perspective view of the third polarizing beam splitter PBS₃ and illustrates the interior of a bounding outline VIII illustrated in FIG. 7 in greater detail. An X direction, a Y direction, and a Z direction perpendicular to each other are common in FIGS. 7 and 8.

The first and fourth polarizing beam splitters PBS₁ and PBS₄ include optical thin films perpendicular to the plane of FIG. 7, while the third polarizing beam splitter PBS₃ includes an optical thin film non-perpendicularly intersecting the plane of FIG. 7, that is, a YZ plane.

The third λ/2 wavelength plate λ/2P₃ is disposed in an optical path of excitation light B₃₀ transmitted through the first polarizing beam splitter PBS₁. The third λ/2 wavelength plate λ/2P₃ is configured to be rotated by a rotation mechanism similar to the rotation mechanism AC₂ described above referring to FIG. 4, allowing for rotation of the direction of the optical axis A₂. The rotation mechanism that rotates the third λ/2 wavelength plate λ/2P₃ corresponds to a fourth rotation mechanism in the present disclosure.

The fourth polarizing beam splitter PBS₄ is disposed in an optical path of excitation light B₃₁ transmitted through the third λ/2 wavelength plate λ/2P₃.

### 3.2 Operation

### 3.2.1 Light Amount Adjustment for First Light

When the polarization direction of the excitation light B₁₁ and the direction of the optical axis A₂ of the second λ/2 wavelength plate λ/2P₂ are coincident with each other, the polarization direction of the excitation light B₁₂ is the same as the polarization direction of the excitation light B₁₁ and is perpendicular to the plane of FIG. 7. As illustrated in FIG. 8, the polarization component perpendicular to the plane of FIG. 7 is P-polarized with respect to the optical thin film of the third polarizing beam splitter PBS₃ and is transmitted through the third polarizing beam splitter PBS₃ as excitation light B₁₃.

If the second λ/2 wavelength plate λ/2P₂ is rotated, the polarization direction of the excitation light B₁₂ can be changed in accordance with the direction of the optical axis A₂, and can be made non-perpendicular to the plane of FIG. 7. The polarization component of the excitation light B₁₂ parallel to the plane of FIG. 7 is S-polarized with respect to the optical thin film of the third polarizing beam splitter PBS₃ and is reflected by the third polarizing beam splitter PBS₃ as excitation light B₁₄. An unillustrated beam damper is disposed in an optical path of the excitation light B₁₄. The division ratio of the excitation light B₁₃ and the excitation light B₁₄ by the third polarizing beam splitter PBS₃ is adjusted, and consequently, the light amount of the excitation light B₁₃ is adjusted, by adjusting the polarization direction of the excitation light B₁₂.

A part of the excitation light B₁₃ may not be absorbed in the laser amplification medium AMP, may exit the second end E₂ as excitation light B₁₉, and may be incident on the fourth polarizing beam splitter PBS₄ as excitation light B₂₃. The excitation light B₂₃ has a polarization direction perpendicular to the plane of FIG. 7, is S-polarized with respect to the optical thin film of the fourth polarizing beam splitter PBS₄, and is thus reflected as excitation light B₂₄. An unillustrated beam damper is disposed in an optical path of the excitation light B₂₄.

### 3.2.2 Light Amount Adjustment for Second Light

The light amount adjustment for the second light differs from the light amount adjustment for the first light in that the third λ/2 wavelength plate λ/2P₃ and the fourth polarizing beam splitter PBS₄ are used instead of the second λ/2 wavelength plate λ/2P₂ and the third polarizing beam splitter PBS₃. When the polarization direction of the excitation light B₃₀ and the direction of the optical axis A₂ of the third λ/2 wavelength plate λ/2P₃ are coincident with each other, the polarization direction of the excitation light B₃₁ is the same as the polarization direction of the excitation light B₃₀. The excitation light B₃₁ in that case is P-polarized with respect to the optical thin film of the fourth polarizing beam splitter PBS₄ and is transmitted through the fourth polarizing beam splitter PBS₄ as excitation light B₃₂.

If the third λ/2 wavelength plate λ/2P₃ is rotated, the polarization direction of the excitation light B₃₁ can be changed. The polarization component of the excitation light B₃₁ perpendicular to the plane of FIG. 7 is reflected by the fourth polarizing beam splitter PBS₄ as excitation light B₃₃. An unillustrated beam damper is disposed in an optical path of the excitation light B₃₃. The amount of the excitation light B₃₂ is adjusted by adjusting the polarization direction of the excitation light B₃₁.

A part of the excitation light B₃₂ may not be absorbed in the laser amplification medium AMP, may exit the first end E₁ as excitation light B₃₈, and may be incident on the third polarizing beam splitter PBS₃ as excitation light B₄₂. The excitation light B₄₂ has a polarization direction parallel to the plane of FIG. 7, is S-polarized with respect to the optical thin film of the third polarizing beam splitter PBS₃, and is thus reflected as excitation light B₄₃ as illustrated in FIG. 8. An unillustrated beam damper is disposed in an optical path of the excitation light B₄₃.

### 3.3 Effects

(8) According to the second embodiment, the laser amplifier 1d further includes the second λ/2 wavelength plate λ/2P₂ located in the optical path of the first light between the first polarizing beam splitter PBS₁ and the laser amplification medium AMP, and the third polarizing beam splitter PBS₃ located in the optical path of the first light between the second λ/2 wavelength plate λ/2P₂ and the laser amplification medium AMP.

With this configuration, the light amount of the first light can be set independently of the second light by using the second λ/2 wavelength plate λ/2P₂ and the third polarizing beam splitter PBS₃.

(9) According to the second embodiment, the laser amplifier 1d further includes the rotation mechanism configured to rotate the second λ/2 wavelength plate λ/2P₂ to change the optical axis A₂ of the second λ/2 wavelength plate λ/2P₂.

With this configuration, the light amount of the first light can be changed independently of the second light by rotating the polarization direction of the excitation light B₁₂.

(10) According to the second embodiment, the laser amplifier 1d further includes the third λ/2 wavelength plate λ/2P₃ located in the optical path of the second light between the first polarizing beam splitter PBS₁ and the laser amplification medium AMP, and the fourth polarizing beam splitter PBS₄ located in the optical path of the second light between the third λ/2 wavelength plate λ/2P₃ and the laser amplification medium AMP.

With this configuration, the light amount of the second light can be set independently of the first light by using the third λ/2 wavelength plate λ/2P₃ and the fourth polarizing beam splitter PBS₄.

(11) According to the second embodiment, the laser amplifier 1d further includes the rotation mechanism configured to rotate the third λ/2 wavelength plate λ/2P₃ to change the optical axis A₂ of the third λ/2 wavelength plate λ/2P₃.

With this configuration, the light amount of the second light can be changed independently of the first light by rotating the polarization direction of the excitation light B₃₁.

In other respects, the second embodiment is similar to the first embodiment. Alternatively, the seed light SB₁ may be amplified twice to output laser light LB in the second embodiment similarly to the first and second modifications of the first embodiment.

### 4. Laser Amplifier 1e Including Pump Laser PL₃ that Outputs Linearly Polarized Light

### 4.1 Configuration

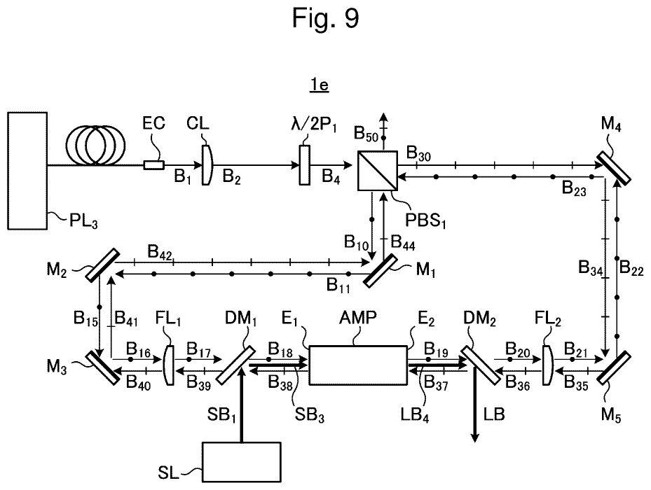

FIG. 9 illustrates a configuration of a laser amplifier 1e according to a third embodiment. The laser amplifier 1e is an example of the double-ended excitation laser amplifier in the present disclosure and includes a pump laser PL₃ that outputs excitation light that is linearly polarized light instead of the pump laser PL. The laser amplifier 1e may not include a first λ/4 wavelength plate λ/4P₁. Illustration of a beam damper D is omitted.

### 4.2 Operation

A collimating lens CL causes excitation light B₂ that is linearly polarized light to exit therefrom. When a polarization direction of the excitation light B₂ and a direction of an optical axis A₂ of a first λ/2 wavelength plate λ/2P₁ are coincident with each other, a polarization direction of excitation light B₄ is the same as the polarization direction of the excitation light B₂. The ratio of an S-polarized component and a P-polarized component with respect to an optical thin film of a first polarizing beam splitter PBS₁ is determined in accordance with the polarization direction of the excitation light B₄. The S-polarized component of the excitation light B₄ is reflected as excitation light B₁₀, and the P-polarized component is transmitted as excitation light B₃₀.

If the first λ/2 wavelength plate λ/2P₁ is rotated by a rotation mechanism AC₂ (see FIG. 4), the polarization direction of the excitation light B₄ can be changed in accordance with the direction of the optical axis A₂. The ratio of the S-polarized component and the P-polarized component with respect to the optical thin film of the first polarizing beam splitter PBS₁ can be adjusted by adjusting the polarization direction of the excitation light B₄.

### 4.3 Effects

(12) According to the third embodiment, the laser amplifier 1e includes the laser amplification medium AMP configured to amplify pulsed seed light SB₁, a pump laser PL₃ configured to output excitation light B₁ that is linearly polarized light, the first λ/2 wavelength plate λ/2P₁ through which the excitation light B₂ is transmitted, the first polarizing beam splitter PBS₁, and focusing lenses FL₁ and FL₂. The first polarizing beam splitter PBS₁ separates the excitation light B₄ transmitted through the first λ/2 wavelength plate λ/2P₁ into first light having a first polarization direction perpendicular to the plane of FIG. 9 and second light having a second polarization direction parallel to the plane of FIG. 9. The focusing lens FL₁ causes the first light to be incident on a first end E₁ of the laser amplification medium AMP, and the focusing lens FL₂ causes the second light to be incident on a second end E₂ of the laser amplification medium AMP.

With this configuration, the ratio of the light amounts of the first light and the second light can be set, and the light amounts of the excitation light B₁₈ and the excitation light B₃₇ incident on the laser amplification medium AMP can be set by defining the polarization state of the linearly polarized excitation light B₄ with the first λ/2 wavelength plate λ/2P₁. In addition, damage on the pump laser PL due to the excitation light B₁₉ and B₃₈ that have not been absorbed in the laser amplification medium AMP can be suppressed.

(13) According to the third embodiment, the laser amplifier 1e further includes a rotation mechanism AC₂ configured to rotate the first λ/2 wavelength plate λ/2P₁ to change the optical axis A₂ of the first λ/2 wavelength plate λ/2P₁.

With this configuration, it is possible to change the ratio of the light amounts of the first light and the second light by rotating the polarization direction of the excitation light B₄.

In other respects, the third embodiment is similar to the first embodiment. Alternatively, the seed light SB₁ may be amplified twice and the laser light LB may be output in the third embodiment similarly to the first and second modifications of the first embodiment.

Alternatively, the light amounts of the first light and the second light may be able to be adjusted in the third embodiment similarly to the second embodiment.

### 5. Others

### 5.1 Electronic Device Including Interposer IP

FIG. 10 schematically illustrates a configuration of an electronic device. The electronic device illustrated in FIG. 10 includes an integrated circuit chip IC, an interposer IP, and a circuit substrate CS.

The integrated circuit chip IC is, for example, a chip in which an unillustrated integrated circuit is formed on a silicon substrate. The integrated circuit chip IC is provided with a plurality of bumps ICB electrically connected to the integrated circuit.

The interposer IP includes an insulating substrate in which a plurality of unillustrated through-holes are formed, and an unillustrated conductor for electrically connecting front and back surfaces of the substrate is provided in each through-hole. A plurality of unillustrated lands connected to the respective bumps ICB are formed on one surface of the interposer IP, and each of the lands is electrically connected to any of the conductors in the through-holes. A plurality of bumps IPB are provided on the other surface of the interposer IP, and each of the bumps IPB is electrically connected to any of the conductors in the through-holes.

A plurality of unillustrated lands connected to the bumps IPB are formed on one surface of the circuit substrate CS. The circuit substrate CS includes a plurality of terminals electrically connected to the respective lands.

FIG. 11 is a flowchart illustrating a method of manufacturing an electronic device. In S1, laser-processing and wiring formation on an interposer substrate included in the interposer IP are performed. The laser processing on the interposer substrate includes forming through-holes by irradiating the interposer substrate with the laser light LB. The wiring formation includes formation of a conductive film on inner wall surfaces of the through-holes formed in the interposer substrate. Through such a process, the interposer IP is produced.

In S2, the interposer IP and the integrated circuit chip IC are coupled. This process includes, for example, disposing the bumps ICB of the integrated circuit chip IC on the lands of the interposer IP and electrically connecting the bumps ICB and the lands.

In S3, the interposer IP and the circuit substrate CS are coupled. This process includes, for example, disposing the bumps IPB of the interposer IP on the lands of the circuit substrate CS and electrically connecting the bumps IPB and the lands.

### 5.2 Supplement

The description above is intended to be illustrative and the present disclosure is not limited thereto. Therefore, it would be obvious to those skilled in the art that various modifications to the embodiments of the present disclosure would be possible without departing from the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of “A”, “B”, “C”, “A+B”, “A+C”, “B+C”, and “A+B+C”. In addition, combinations of them with other than “A”, “B”, and “C” should also be construed as being included.

What is claimed is:

1. A double-ended excitation laser amplifier comprising:
a laser amplification medium configured to amplify pulsed seed light;
an excitation light source configured to output excitation light;
a first λ/4 wavelength plate and a first λ/2 wavelength plate through which the excitation light is transmitted;
a first polarizing beam splitter configured to separate the excitation light transmitted through the first λ/4 wavelength plate and the first λ/2 wavelength plate into first light having a first polarization direction and second light having a second polarization direction;
a first incident optical system configured to cause the first light to be incident on a first end of the laser amplification medium; and
a second incident optical system configured to cause the second light to be incident on a second end of the laser amplification medium.

2. The double-ended excitation laser amplifier according to claim 1, further comprising:
a first rotation mechanism configured to rotate the first λ/2 wavelength plate to change an optical axis of the first λ/2 wavelength plate.

3. The double-ended excitation laser amplifier according to claim 1, further comprising:
a second rotation mechanism configured to rotate the first λ/4 wavelength plate to change an optical axis of the first λ/4 wavelength plate.

4. The double-ended excitation laser amplifier according to claim 1, further comprising:
a second polarizing beam splitter configured to cause the seed light that is linearly polarized light having a third polarization direction to pass through the second polarizing beam splitter to be incident on the first end;
a high reflective mirror configured to reflect the seed light exiting the second end and to return the seed light to the second end; and
a second λ/4 wavelength plate located in an optical path of the seed light between the second end and the high reflective mirror and disposed to convert the linearly polarized light having the third polarization direction into circularly polarized light when the seed light directed from the second end to the high reflective mirror passes through the second λ/4 wavelength plate, and to convert the circularly polarized light into linearly polarized light having a fourth polarization direction when the seed light directed from the high reflective mirror to the second end passes through the second λ/4 wavelength plate, wherein
the second polarizing beam splitter is located in an optical path of laser light, the laser light being obtained by amplifying the seed light that is the linearly polarized light having the fourth polarization direction and exiting the first end.

5. The double-ended excitation laser amplifier according to claim 1, wherein
the first light and the second light have same amount of light.

6. The double-ended excitation laser amplifier according to claim 1, wherein
the laser amplification medium is an Yb:YAG crystal, and
the excitation light includes any of 940 nm and 969 nm wavelength components.

7. The double-ended excitation laser amplifier according to claim 1, wherein
the excitation light is continuous-wave light.

8. The double-ended excitation laser amplifier according to claim 1, further comprising:
a second λ/2 wavelength plate located in an optical path of the first light between the first polarizing beam splitter and the laser amplification medium; and
a third polarizing beam splitter located in an optical path of the first light between the second λ/2 wavelength plate and the laser amplification medium.

9. The double-ended excitation laser amplifier according to claim 8, further comprising:
a third rotation mechanism configured to rotate the second λ/2 wavelength plate to change an optical axis of the second λ/2 wavelength plate.

10. The double-ended excitation laser amplifier according to claim 8, further comprising:
a third λ/2 wavelength plate located in an optical path of the second light between the first polarizing beam splitter and the laser amplification medium; and
a fourth polarizing beam splitter located in an optical path of the second light between the third λ/2 wavelength plate and the laser amplification medium.

11. The double-ended excitation laser amplifier according to claim 10, further comprising:
a fourth rotation mechanism configured to rotate the third λ/2 wavelength plate to change an optical axis of the third λ/2 wavelength plate.

12. A double-ended excitation laser amplifier comprising:
a laser amplification medium configured to amplify pulsed seed light;
an excitation light source configured to output excitation light that is linearly polarized light;
a first λ/2 wavelength plate through which the excitation light is transmitted;
a first polarizing beam splitter configured to separate the excitation light transmitted through the first λ/2 wavelength plate into first light having a first polarization direction and second light having a second polarization direction;
a first incident optical system configured to cause the first light to be incident on a first end of the laser amplification medium; and
a second incident optical system configured to cause the second light to be incident on a second end of the laser amplification medium.

13. The double-ended excitation laser amplifier according to claim 12, further comprising:
a first rotation mechanism configured to rotate the first λ/2 wavelength plate to change an optical axis of the first λ/2 wavelength plate.

14. The double-ended excitation laser amplifier according to claim 12, further comprising:
a second polarizing beam splitter configured to cause the seed light that is linearly polarized light having a third polarization direction to pass through the second polarizing beam splitter to cause the seed light to be incident on the first end;
a high reflective mirror configured to reflect the seed light exiting the second end and to return the seed light to the second end; and
a λ/4 wavelength plate located in an optical path of the seed light between the second end and the high reflective mirror and disposed to convert the linearly polarized light having the third polarization direction into circularly polarized light when the seed light directed from the second end to the high reflective mirror passes through the λ/4 wavelength plate, and to convert the circularly polarized light into linearly polarized light having a fourth polarization direction when the seed light directed from the high reflective mirror to the second end passes through the λ/4 wavelength plate, wherein
the second polarizing beam splitter is located in an optical path of laser light, the laser light being obtained by amplifying the seed light that is the linearly polarized light having the fourth polarization direction and exiting from the first end.

15. The double-ended excitation laser amplifier according to claim 12, further comprising:
a second λ/2 wavelength plate located in an optical path of the first light between the first polarizing beam splitter and the laser amplification medium; and
a third polarizing beam splitter located in an optical path of the first light between the second λ/2 wavelength plate and the laser amplification medium.

16. The double-ended excitation laser amplifier according to claim 15, further comprising:
a third rotation mechanism configured to rotate the second λ/2 wavelength plate to change an optical axis of the second λ/2 wavelength plate.

17. The double-ended excitation laser amplifier according to claim 15, further comprising:
a third λ/2 wavelength plate located in an optical path of the second light between the first polarizing beam splitter and the laser amplification medium; and
a fourth polarizing beam splitter located in an optical path of the second light between the third λ/2 wavelength plate and the laser amplification medium.

18. The double-ended excitation laser amplifier according to claim 17, further comprising:
a fourth rotation mechanism configured to rotate the third λ/2 wavelength plate to change an optical axis of the third λ/2 wavelength plate.

19. A method of manufacturing an electronic device comprising:
generating laser light with a laser device, the laser device including a seed laser configured to output pulsed seed light,
a laser amplification medium configured to amplify the seed light,
an excitation light source configured to output excitation light,
a first λ/4 wavelength plate and a first λ/2 wavelength plate through which the excitation light is transmitted,
a first polarizing beam splitter configured to separate the excitation light transmitted through the first λ/4 wavelength plate and the first λ/2 wavelength plate into first light having a first polarization direction and second light having a second polarization direction,
a first incident optical system configured to cause the first light to be incident on a first end of the laser amplification medium, and
a second incident optical system configured to cause the second light to be incident on a second end of the laser amplification medium;
producing an interposer by laser processing on an interposer substrate with the laser light;
coupling and electrically connecting the interposer and an integrated circuit chip to each other; and
coupling and electrically connecting the interposer and a circuit substrate to each other.

20. A method of manufacturing an electronic device comprising:
generating laser light with a laser device, the laser device including
a seed laser configured to output pulsed seed light,
a laser amplification medium configured to amplify the seed light,
an excitation light source configured to output excitation light that is linearly polarized light,
a first λ/2 wavelength plate through which the excitation light is transmitted,
a first polarizing beam splitter configured to separate the excitation light transmitted through the first λ/2 wavelength plate into first light having a first polarization direction and second light having a second polarization direction,
a first incident optical system configured to cause the first light to be incident on a first end of the laser amplification medium, and
a second incident optical system configured to cause the second light to be incident on a second end of the laser amplification medium;
producing an interposer by laser processing on an interposer substrate with the laser light;
coupling and electrically connecting the interposer and an integrated circuit chip to each other; and
coupling and electrically connecting the interposer and a circuit substrate to each other.
